(19) United States
(12) Patent Application Publication
(10) Pub. No.: US 2009/0003579 A1
(43) Pub. Date: Jan. 1, 2009

(54) APPARATUS AND METHOD FOR PROVIDING CALL DEFLECTION

(75) Inventors: Amit Singh, Irving, TX (US); Fariborz Ebrahimi, Arlington, VA (US); Dinyar Kavouspour, Plano, TX (US); Roopa Kotha, Irving, TX (US); Bipin Sakamuri, Irving, TX (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Data Services Inc., Temple Terrace, FL (US)

(21) Appl. No.: 11/771,229

(22) Filed: Jun. 29, 2007

(51) Int. Cl. H04M 3/42

(52) U.S. Cl. 379/211.01

(57) ABSTRACT

An approach is disclosed for providing call deflection. A voice call or chat is initiated by a user to an agent to satisfy an inquiry is received. The voice call/chat is placed in a call/chat queue. The voice call/chat is deflected by invoking a data application that is accessed by the user over a data session to address the inquiry, wherein the voice call/chat is terminated if the inquiry is satisfied by through the data application.

### BACKGROUND INFORMATION

Providing high quality service to customers has become a primary consideration by organizations and companies, such as those in the telecommunications, manufacturing, finance, as well as other service oriented businesses that are seeking to gain a competitive edge in the market. To this end, companies in these sectors spend significant amounts of money to provide a high level of customer service. For example, enormous investments have been made to establish call centers for handling customer inquiries. Traditionally, companies, for example, attempt to provision toll-free customer service telephone numbers for such call centers, so that customers can reach their service representatives with incurring cost. To handle larger volume of traffic, the technique of call deflection has been utilized which diverts incoming connections to other terminals, or to voice response systems for automatic spoken announcements. However, conventional call deflection systems have not focused on the users' experience.

For efficiency purposes, in many instances, before connecting customers to a customer service representative, companies choose to initially handle customer calls with a front end call processor, such as interactive voice response (IVR) system. Such systems provide information automatically to customers over the telephone either by accessing their accounts and orally providing account details or general information. After supplying the information, users are placed on hold and left waiting until the service representative is available. These systems can entail long wait times before a customer can actually speak with a customer service representative in person. Under certain circumstance, during peak traffic times, the customer may not be able to obtain service at all. Some systems have attempted to mitigate the frustration of waiting by deflecting the call to announcement systems or playing background music. This experience can quickly be an annoyance if the user has to return to the system, and is presented with the same music and announcements.

With the expansion of the Internet, having a user friendly website with complete, accurate, and up-to-date information has been a critical part of providing this high level of customer service. Most companies also provide users with personal web accounts so that they may be able to log in and check personal information such as account balances, recent orders, payments, billing information etc. Frequently, however, customers are not able to find the exact information they are looking for through the companies' website, in part because the interface is overly complex or because the information is simply too voluminous. Additionally, even if the information can be found, the task may be too time consuming.

From the company's perspective, providing customer support through a customer service representative is not appealing in that every extra minute spent by a customer service representative on the telephone translates into significant costs to the company, in terms of telecommunication costs and personnel cost.

Based on the foregoing, there is a clear need for an effective approach to provide handling of inquiries through voice calls, while enhancing the user experience.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a communication system capable of providing call deflection, according to various exemplary embodiments;

FIG. 2 is a flowchart of a call deflection process for diverting a user to a website, according to an exemplary embodiment;

FIG. 3 is a flowchart of a call deflection process for diverting a voice caller to a chat session, according to an exemplary embodiment;

FIG. 4 is a diagram of a call deflection system, according to an exemplary embodiment;

FIG. 5 is a flowchart of a call deflection process that provides dynamic generation of a customized website, according to an exemplary embodiment; and

FIG. 6 is a diagram of a computer system that can be used to implement various exemplary embodiments.

### DETAILED DESCRIPTION OF PREFERRED EMBODIMENTS

An apparatus, method, and software for providing call deflection are described. In the following description, for the purposes of explanation, numerous specific details are set forth in order to provide a thorough understanding of the various exemplary embodiments. It is apparent, however, to one skilled in the art that the various exemplary embodiments may be practiced without these specific details or with an equivalent arrangement. In other instances, well-known structures and devices are shown in block diagram form in order to avoid unnecessarily obscuring the exemplary embodiments.

Although the various embodiments are described with respect to web-based applications, it is contemplated that these embodiments have applicability to other equivalent applications.

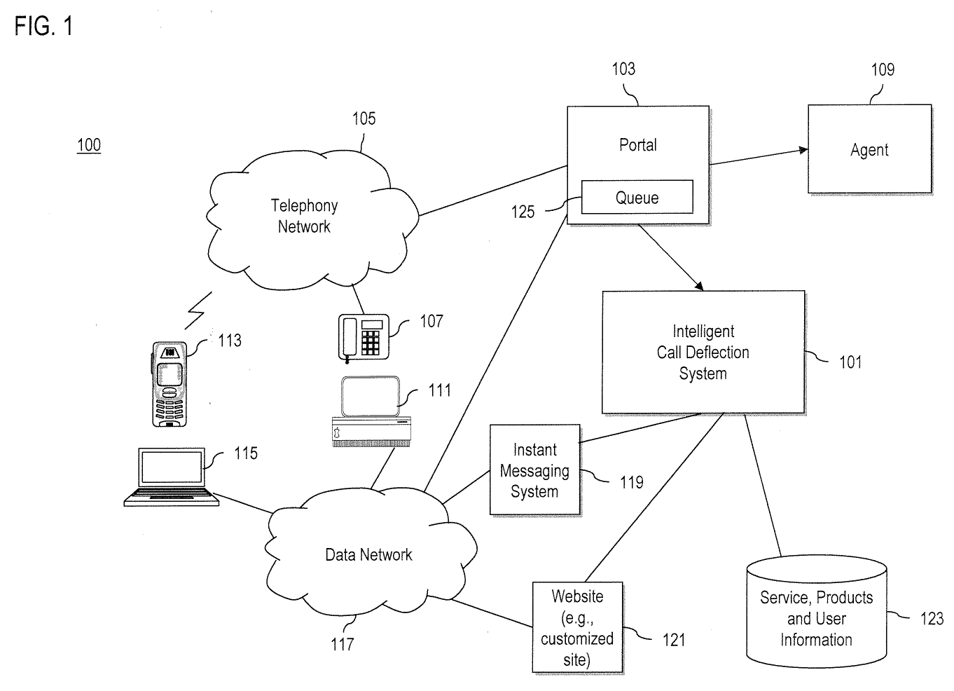

FIG. 1 is a diagram of a communication system capable of providing call deflection, according to various exemplary embodiments. The communication system 100 includes an intelligent call deflection system 101 that provides deflection (or redirection) of communication sessions (e.g., voice calls or chat sessions) to a data application, such as a website or an instant messaging (IM) application based on criteria, such as agent availability, volume of chats, availability of chat service, etc. It is recognized that users are oftentimes frustrated with the traditional forms of electronic access to information. For instance, the users may not be versed in navigating through websites, and thus, are not able to timely find information. Also, an enormous amount of information is provided within websites, thereby further increasing the difficulty of location information. In addition, users can be overwhelmed with the complexity of the web pages' menu structure as well as the massive amount of irrelevant (untargeted) information that is provided. Furthermore, customers may prefer to talk with a representative on the phone to ask questions, resolve their issues, or to obtain a particular, personalized piece of information. In recognition of the above issues, the call deflection system 101 integrates the electronic forms of data and telephony applications to enhance the user experience.

A communication portal 103 interfaces with a telephony network 105 to receive a voice call from a user. In one embodiment, the communications portal 103 includes components for processing voice calls from traditional circuit switched telephone connections as well as packetized voice streams. For instance, such components (not shown) can comprise an interactive voice response (IVR) application for collecting information from the caller. That is, the IVR application associated can query the caller for information pertinent to the call. Optionally, the communications portal 103 can include an automatic call distributor (ACD) for switching calls to an appropriate agent.

By way of example, the user can utilize a voice station 107 to initiate a call to an agent 109. The voice station 107 can be a traditional Plain Old Telephone Service (POTS) phone, or alternatively, a packetized voice station (e.g., Voice or IP (Internet Protocol) capable device). It is assumed that the user of the voice station 107 also has access to a computing device 111 (e.g., desktop personal computer, workstation, web appliance, etc.) in the vicinity of the voice station 107. In addition, another user may utilize a mobile device 113 to establish a voice call with the agent 109; this particular user can also communicate using a mobile computing device 115 (e.g., laptop computer, palm computer, etc.). The computing device 111 and the mobile computing device 115, each has connectivity to a data network 117. According to certain embodiments, the access technologies for these devices include digital subscriber line (DSL) and cable modem, as well as wireless mechanisms (e.g., WiFi (Wireless Fidelity), Bluetooth™, WiMax (Worldwide Interoperability for Microwave Access), cellular, etc.).

The portal 103 also interfaces with the data network 117 to support chat sessions from the devices 111, 115.

For the purposes of illustration, the call deflection system 101, according to certain embodiments, is described with respect to deployment within a service provider or organization that employs one or more agents 109 to assist a customer with services and products offered by the service provider. The agent 109 is, for instance, a customer service representative who can provide such services as provisioning, trouble-ticket handling, technical support, accounting, etc.

Under this scenario, the call deflection system 101, in conjunction, with the communications portal 103 provides call deflection such that a call from a customer is diverted to a chat session through an instant messaging system 119 or a website 121. The website 121, according to an exemplary embodiment, can be customized (personalized), as later described below. The call deflection system 101 has access to data about the services and products of the service provider, as well as information about the customers; this information is stored in database 123.

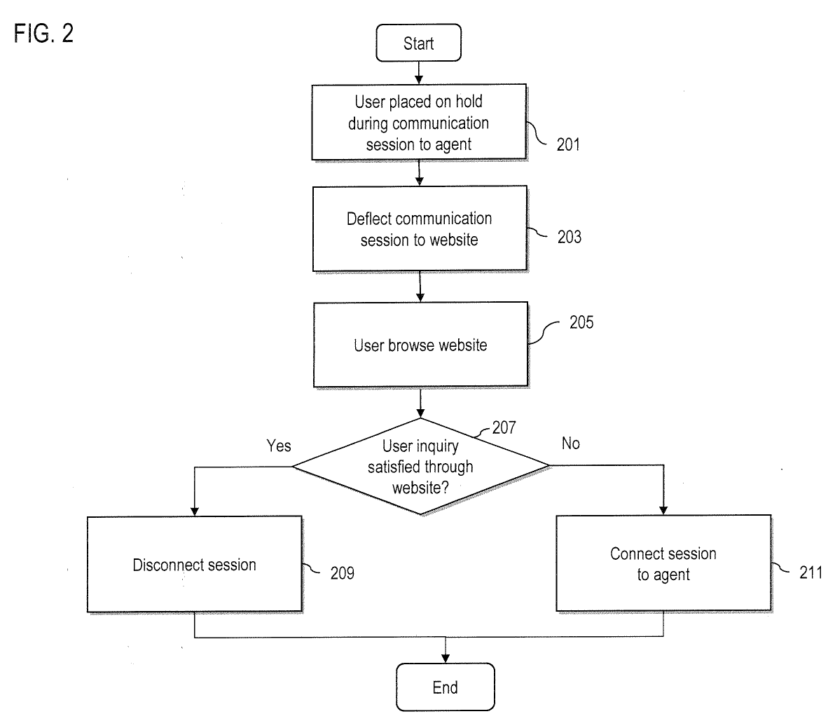

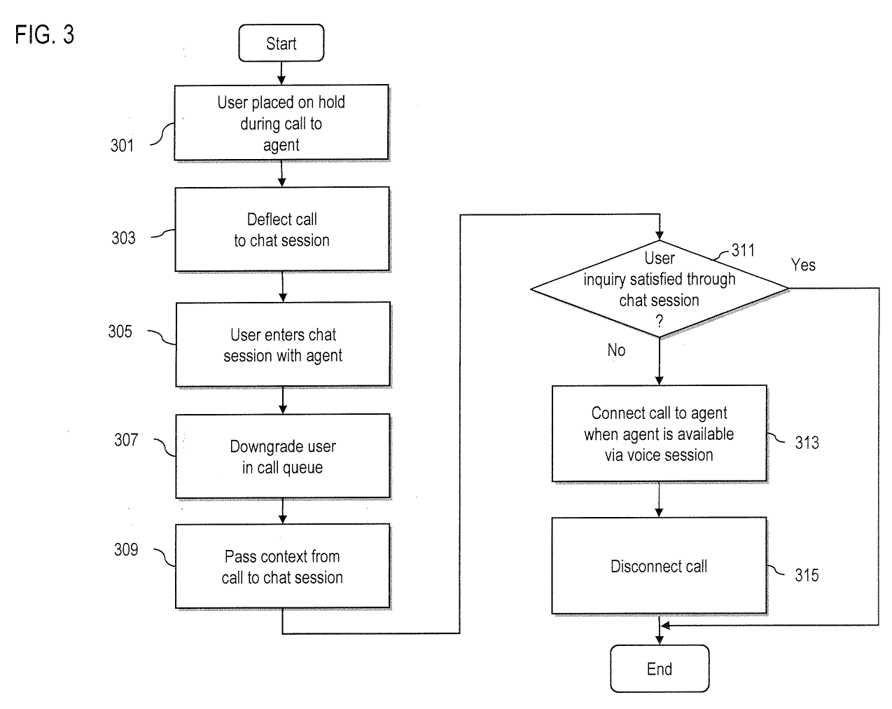

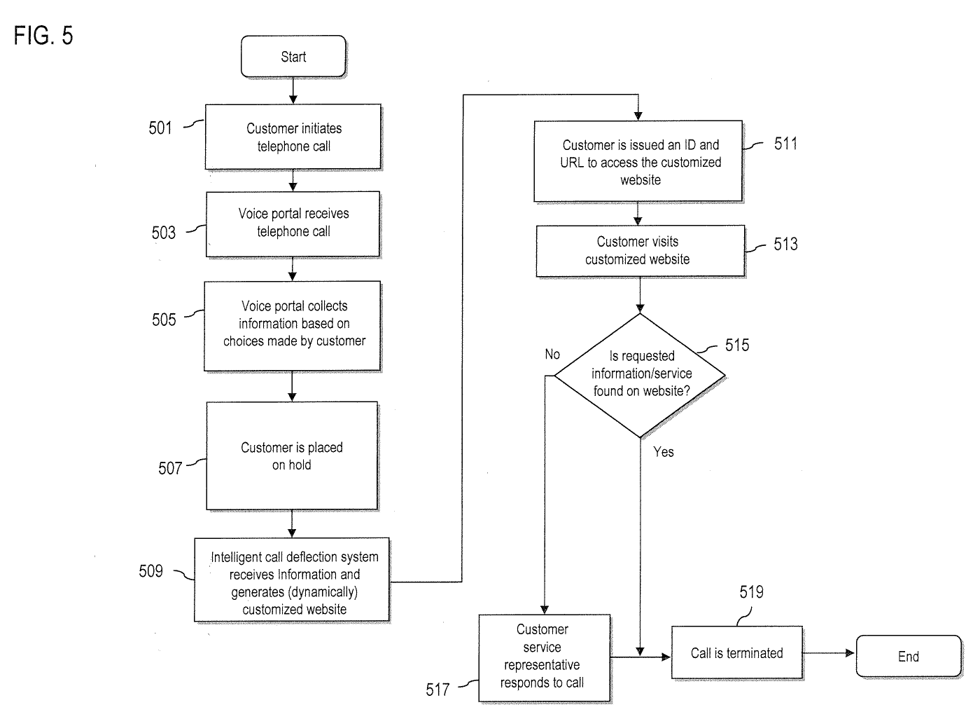

Deflecting a call from a customer that has initiated customer support through a telephone (e.g., station 107 or cellular handset 113) to the customized website 121 via the intelligent call deflection system 101 can significantly reduce the cost of providing customer support by the organization. Also, the customer can experience higher levels of customer satisfaction in that the customer is not made to wait unnecessarily, but may be able to obtain information that is sought through other means, which may be more efficient than actually speaking with the agent 109. Such means include the customer being directed to access the customized website 121, as detailed in FIGS. 2 and 5. Further, the voice call can result in the customer engaging in a chat session, which is more fully described in FIG. 3.

FIG. 2 is a flowchart of a call deflection process for diverting a user to a website, according to an exemplary embodiment. In the example, the voice station 107 or device 111 communicates with the communications portal 103 in support of a user (e.g., customer) seeking to contact the agent 109. The user thus seeks to find information about a particular inquiry, e.g., status of an order, procedure for reporting service problems, etc. In step 201, the user is placed “on hold” in a communications queue 125. The call deflection system 101 detects that the communications queue 125 has one or more communication sessions parked there, and deflects the communication session, per step 203, to the website 121; i.e., instead of connecting the user immediately to the agent 109, the user is provided with the capability to resolve the inquiry via the website 121. The customer can then, while on hold, browse the designated website 121 using the computing device 111, for example (step 205). During this browsing, the customer may find information that satisfies the user's inquiry through the website 121 (as determined in step 207); if the customer's inquiry is satisfied, then the communication session is disconnected, per step 209. Otherwise, the customer may still communicate with the agent, and thus, is connected to the agent 109, once the agent 109 is available, as in step 211.

It is contemplated that the website experience can be enhanced through customization of the website 121 for the specific needs of the customer. In an exemplary embodiment, the customized website 121 can be generated dynamically. This process is detailed in FIG. 5.

In addition to the above deflection to a website, if the communication session is a voice call, the call may be directed to, for example, a chat session, as next explained. If, however, the communication session is a chat session, the deflection would result in diverting the user to only the website.

FIG. 3 is a flowchart of a call deflection process for diverting a caller to a chat session, according to an exemplary embodiment. Under this scenario, a user is placed on hold—i.e., parked in the communications queue 125 (which would be call queue), per step 301. In step 303, the call deflection system 101 determines that the agent 109 is available via a chat session, and hence, deflects the call to the chat session (step 303). At this point, the IM system 119 performs the function of determining presence of the caller and the agent 109, and coordinates the chat session establishment. Upon the caller entering the chat session with the agent 109, the user's position in the queue 125 can be “downgraded.” That is, because the user is presently communicating with the agent 109, the call will not likely need to be completed. As a consequence, other users can be put ahead of the caller.

According to one embodiment, the communications portal 103 can collect user information in the initial treatment of the call. Such context information can be passed to the chat session, as in step 309. For instance, if the user entered an identification number (e.g., account number, user identification, personal identification number (PIN), etc.), this information is converted into textual form and provided to the agent 109.

In step 311, the process determines whether the user inquiry is satisfied through this chat session. If the user cannot complete the inquiry (or transaction), then the user can still communicate with the agent 109 via the voice call, as in step 313. Thereafter, the call is disconnected, per step 315.

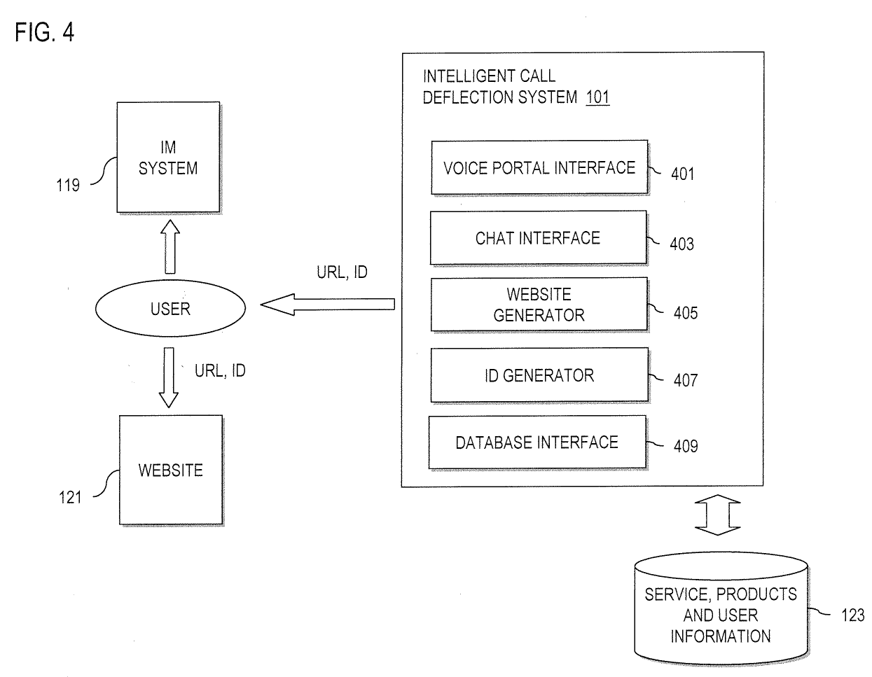

FIG. 4 is a diagram of a call deflection system, according to an exemplary embodiment. As shown, the call deflection system 101 includes a voice portal interface 401 for communicating with the communications portal 103. Additionally, a chat interface 403 enables the deflection of calls within the communications queue 125 to be directed to the IM system 119. Furthermore, a website generator 405 is included to create a customized website for the caller. The call deflection system 101 also has an identifier (ID) generator 407, which produces an identifier that the caller can utilized to access the customized website 121.

To access user information, as well as data concerning the services and products of the service provider, a database interface 409 couples to the database 123.

FIG. 5 is a flowchart of a call deflection process that provides dynamic generation of a customized website, according to an exemplary embodiment. By way of example, in step 501, a customer dials, for instance, a telephone number to reach the customer service representative 109 via a telephone connection to request customer support. The call is answered, as in step 503, by the communications portal 103, which, according to one embodiment, automatically collects information (step 505) regarding what the customer is searching for; this data collection process can be performed using an interactive voice response (IVR) application (not shown). Namely, the information can be input using a series of questions and selection of answers.

In step 507, the customer is directed to the appropriate customer service representative, e.g., the agent 109. The customer is then placed on hold—i.e., entered into the call queue 125 (step 509). In step 511, the communications portal 103 issues the information supplied by the customer to the intelligent call deflection system 101, which creates the customized website 121. In an exemplary embodiment, the amount of information that is collected from the customer using the communications portal 103 can be collected incrementally to narrow down the scope of the information that can be consolidated for the personalized website 121 that will be generated for the customer. The questions and responses present in the communications portal 103 can be mapped to information within the database 123—e.g., products, services and customer orders, etc. Based on the responses supplied by the customer, the corresponding information can be selected and presented in the personalized website 121.

This creation of the website 121 can be performed dynamically; namely, the website 121 is not in existence prior to the voice call from the customer. As this may process may take some time, it is contemplated that the website generation process can be performed concurrently with the steps of 507 and 509, as to minimize delay.

The communications portal 103 provides information, as in step 513, to the customer on how this customized website 121 may be accessed, such as the address information or location (e.g., uniform resource locator (URL)) of the website 121 and an associated customer ID. This website 121 may then be accessed by the customer via the data network 117 over a data connection, per step 515.

By way of example, the website 121 is populated with information that has been consolidated based on the customer's information needs, as submitted by the customer via the communications portal 103. If the customer is not able to find the requested information or service, as in step 517, the voice call remains in the call queue 125 and is responded to by the customer service representative 109 (step 519). Thereafter, the call is terminated, per step 521. However, if the call deflection is successful and the customer finds the desired information, the call is terminated.

In certain scenarios, call wait times may be too short and the customer service representative 109 may pick up the call before the customer has had a chance to browse the customized website 121 to locate the information the customer is seeking, or the customer may not find the exact information on the customized website 121. In either case, intelligent call deflection results can enhance customer satisfaction in that the customer is engaged, and not idle.

The above described processes relating to call deflection may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

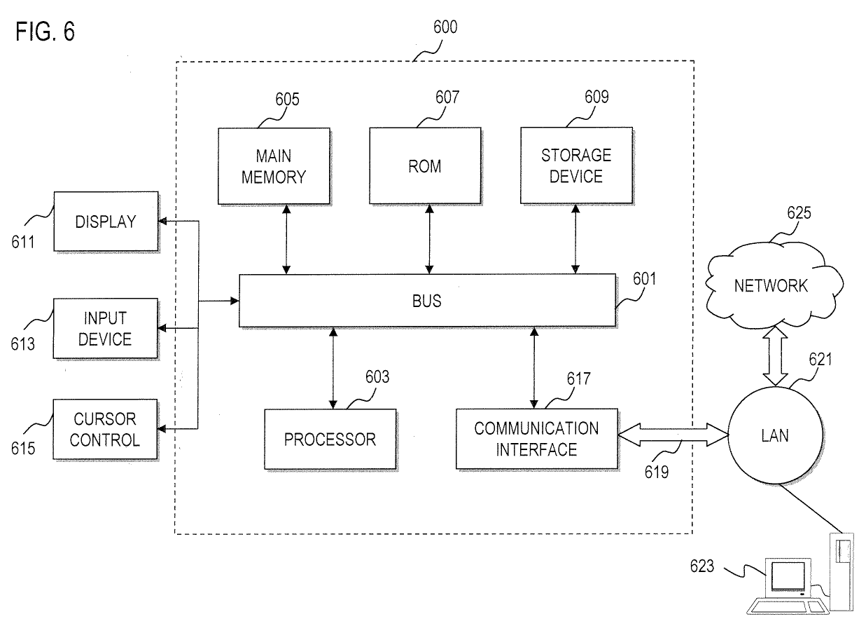

FIG. 6 illustrates a computer system 600 upon which an exemplary embodiment can be implemented. For example, the processes described herein can be implemented using the computer system 600. The computer system 600 includes a bus 601 or other communication mechanism for communicating information and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to one embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the exemplary embodiment. Thus, exemplary embodiments are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an exemplary embodiment through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the various exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. A method comprising:
receiving a communication session initiated by a user to an agent to satisfy an inquiry, wherein the communication session is placed in a queue; and
deflecting the communication session by invoking a data application that is accessed by the user over a data session to address the inquiry, wherein the communication session is terminated if the inquiry is satisfied by through the data application.

2. A method according to claim 1, wherein the data application is a website, the method further comprising:
generating the website; and
creating a user identifier for accessing the website by the user.

3. A method according to claim 2, the method further comprising:
collecting user information through the communication session, wherein the website is customized for the user based on the collected user information.

4. A method according to claim 2, the method further comprising:
providing, to the user over the communication session, the user identifier and addressing information to access the website.

5. A method according to claim 4, the addressing information includes a uniform resource location (URL).

6. A method according to claim 1, wherein the data application is an instant messaging application for establishing a chat session between the user and the agent over the data session, the method further comprising:
collecting user information through the voice call; and
passing the collected information through the chat session to the agent.

7. A method according to claim 1, wherein the agent is a service representative of a service provider, and the user is a customer of the service provider.

8. A method according to claim 1, wherein the communication session is either a voice call or a chat session.

9. An apparatus comprising:
a portal interface coupled to a portal and configured to receive a communication session, from the portal, initiated by a user to an agent to satisfy an inquiry, wherein the communication session is placed in a queue; and
logic configured to invoke a data application that is accessed by the user over a data session to address the inquiry, wherein the communication session is terminated if the inquiry is satisfied by through the data application.

10. An apparatus according to claim 9, wherein the data application is a website, the apparatus further comprising:
a website generator configured to generate the website; and
an identifier generator configured to create a user identifier for accessing the website by the user.

11. An apparatus according to claim 10, wherein the portal is configured to collect user information through the communication session, wherein the website is customized for the user based on the collected user information.

12. An apparatus according to claim 10, wherein the user identifier and addressing information to access the website is provided to the user over the communication session.

13. An apparatus according to claim 12, the addressing information includes a uniform resource location (URL).

14. An apparatus according to claim 9, wherein the portal is configured to collect user information through the communication session, and the data application is an instant messaging application for establishing a chat session between the user and the agent over the data session, the apparatus further comprising:
a chat interface configured to pass the collected information through the chat session to the agent.

15. An apparatus according to claim 9, wherein the agent is a service representative of a service provider, and the user is a customer of the service provider.

16. An apparatus according to claim 9, wherein the communication session is either a voice call or a chat session.

17. A system comprising:
a portal configured to receive a communication session initiated by a user to an agent to satisfy an inquiry, wherein the communication session is placed in a queue; and
a call deflection system coupled to the portal and configured to deflect the communication session by invoking a data application that is accessed by the user over a data session to address the inquiry, wherein the communication session is terminated if the inquiry is satisfied by through the data application.

18. A system according to claim 17, wherein the data application is a website, the call deflection system including,
a website generator configured to generate the website; and
an identifier generator configured to create a user identifier for accessing the website by the user.

19. A system according to claim 18, wherein the portal is further configured to collect user information through the communication session, wherein the website is customized for the user based on the collected user information.

20. A system according to claim 18, wherein the call deflection system is further configured to provide, to the user over the communication session, the user identifier and addressing information to access the website.

21. A system according to claim 20, the addressing information includes a uniform resource location (URL).

22. A system according to claim 17, wherein the portal is configured to collect user information through the communication session, and the data application is an instant messaging application for establishing a chat session between the user and the agent over the data session, the call deflection system further including,
a chat interface configured to pass the collected information through the chat session to the agent.

23. A system according to claim 17, wherein the agent is a service representative of a service provider, and the user is a customer of the service provider.

24. A system according to claim 17, wherein the communication session is either a voice call or a chat session.
